(19) United States
(12) Patent Application Publication
(10) Pub. No.: US 2007/0028250 A1
(43) Pub. Date: Feb. 1, 2007

(54) Locking device

(75) Inventors: Hung Chang Chien, Hsinchu (TW); Kun Chang Chang, Hsinchu (TW)

Correspondence Address: BIRCH STEWART KOLASCH & BIRCH, PO BOX 747, FALLS CHURCH, VA, 22040-0747, US

(73) Assignee: Lite-On It Corporation

(21) Appl. No.: 11/237,679

(22) Filed: Sep. 29, 2005

(30) Foreign Application Priority Data
Jul. 27, 2005 (TW) 094125460

(51) Int. Cl. G11B 17/04; G11B 33/02; G11B 17/03

(52) U.S. Cl. 720/610

(57) ABSTRACT

A locking device for locking a disc loading tray or a cover of disc drives is provided. The locking device comprises a hooking portion, a locking mechanism, a driver set and a control switch, in which the locking mechanism comprises a hook. When the hook is moved to a first position, it is engaged with the hooking portion, and when the hook is moved to a second position, it releases the hooking portion to cause the tray to be ejected out or the cover to be opened. When the driver set drives the hook to leave the first position, the hook triggers the control switch to cause the potential state in the control switch to be changed. The driver set can be accurately controlled to stop at a first time by detecting the change of the potential state in the control switch. Whereby, the driver set can obtain a longer braking distance and prevent the cam form hindering the hook to return to the first position due to the inertia of the motor or the signal delay.

This Non-provisional application claims priority under 35 U.S.C. §119(a) on Patent Application No(s). 094125460 filed in Taiwan, Republic of China on Jul. 27, 2005, the entire contents of which are thereby incorporated by reference.

### FIELD OF THE INVENTION

The present invention relates to a locking device, and more particularly to a locking device used for fixing a cover or a tray in a machine.

### DESCRIPTION OF RELATED ART

Disc loading device applied on an electronic device such as a disc drive or a DVD video camera, according to its loading manner, can be classified into a tray loading type and cover opening type. Here, the tray loading type uses a tray capable of loading a disc to load or eject in or out from the electronic device for optical pickup unit to read data on the surface thereof. And, the disc loading method of the cover opening type mainly includes opening the cover disposed on an electronic device, placing a disc directly into the electronic device, and then closing the cover thereafter so as to allow an optical pickup unit to read the data on the surface of the disc. No matter what type is used, a locking device for locking the cover or the tray in the electronic device is needed.

The locking device can be generally classified into two driving types, i.e. electromagnetic driven type and direct current motor driven type depending on control elements adopted therein. It is used for controlling a hook to separate from a lower cover of an electronic device engaged therewith or from a related component hooked thereby to allow the tray to be ejected out or the cover to be opened for placing a disc in.

Please refer to FIG. 1. FIG. 1 is a schematic view showing a conventional locking device in which an electromagnetic device is used to drive a hook. A locking device driven with an electromagnetic device E mainly uses the attraction force generated from the electromagnetic device E to control the engagement between a hook H and a bolt B disposed on a lower cover of an electronic device so as to cause a tray T to be fixed in the electronic device. When the tray is to be ejected out, there only needs to eliminate the attraction force generated from the electromagnetic device E, and the hook H can then be pushed to separate from the bolt B, as shown in FIG. 1, and the locking state is relieved.

However, the hook H is easily separated from the bolt B when an impulse force larger than the attraction force of the electromagnetic device E is applied on the locking device. Therefore, the tray T is unexpectedly withdrawn from the electronic device when the electronic device is subjected to a reliability test such as a free drop test.

Please also refer to FIGS. 2 and 3. FIG. 2 is a schematic view showing a conventional locking device in which a DC motor is used to drive a hook, and FIG. 3 is a schematic view showing a conventional locking device in which a cam of a locking device stopped at an improper position.

For solving the problems caused from using an electromagnetic device E to drive the locking device, there proposes a structure in which a DC motor is associated with a cam C. Since a hook H and a switch S are installed in a rotating route of the cam C, the hook H can be moved to release a bolt B engaged therewith when the cam C is rotated. Thereafter, the cam C triggers the switch S again to cause the motor M to stop rotating so as to stop the cam C and control the hook H.

However, although such a kind of structure is effective to push the hook H to release the bolt B, the positions at which the cam C stops every time are different and not controllable. Besides, due to the delayed signals of the switch S or the inertia of the motor M, the cam C is even possible to stop at a position hindering the hook H backing to its normal position locking with the bolt B, as shown in FIG. 3. Furthermore, a disc control system has no way to detect what happened of such kind of situation such that the system cannot solve this unexpected situation effectively, and whole locking device is broken down when the cam C stops at the position hindering the hook H backing to its normal position.

Therefore, for solving the problem such as the cam hinders the hook backing to its normal position due to the delayed transmission of signals or the inertia generated from a motor, the present inventors have conducted an investigation on locking device and thus completed this invention.

### SUMMARY OF THE INVENTION

One object of the present invention is to provide a locking device, which can control a driver set to stop at a first time and accurately detect the position of a hook to allow a motor to obtain an enough braking distance, therefore, to prevent a cam from pushing the hook again or stopping on a route hindering the hook backing to its normal position due to the motor inertia or signal delay.

For attaining the object mentioned above, the present invention provides a locking device used for locking a tray or a cover to a disc device. The locking device comprises a hooking portion, a locking mechanism, a driver set, and a control switch; wherein the locking mechanism comprises a hook moved between a first and a second positions. When the hook is moved to the first position, it is engaged with the hooking portion; and when it is moved to the second position, the hooking portion is released to allow the tray being ejected out of the disc device or allow the cover being opened. Furthermore, the control switch is installed on the route that the hook is moved between the first and the second positions.

Therefore, when the hook leaves the first position, the hook triggers the control switch so as to change a potential state of the control switch.

According to the locking device of the present invention, the locking mechanism further comprises:

a shaft fixed on the tray or the cover and used for allowing the hook moving;

an elastic element covered around the shaft and applying an elastic force to push the hook back toward the first position.

According to the locking device of the present invention, the driver set comprises a cam for pushing the hook to move from the first position to the second position and a motor set used to drive the cam to rotate.

According to the locking device of the present invention, the control switch is installed on the moving route of the hook and the hook triggers the control switch directly; the disc system not only can detect the position of the hook, but also allow the motor set to stop the cam moving at a first time through the potential change generated from the control switch so that the motor set obtain an enough braking distance.

### BRIEF DESCRIPTION OF THE DRAWINGS

The present invention can be more fully understood by reference to the following description and accompanying drawings, in which:

FIG. 1 is a schematic view, showing a conventional locking device using an electromagnetic device to drive a hook;

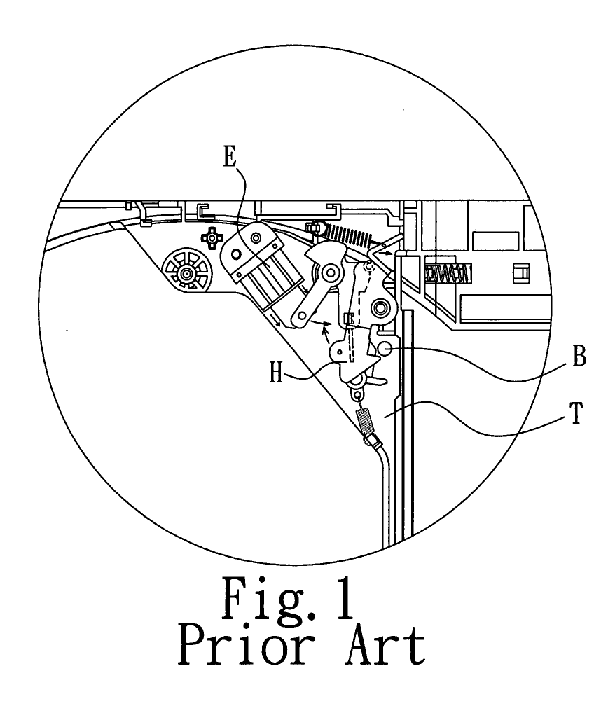

FIG. 2 is a schematic view, showing a conventional locking device using a DC motor to drive a hook;

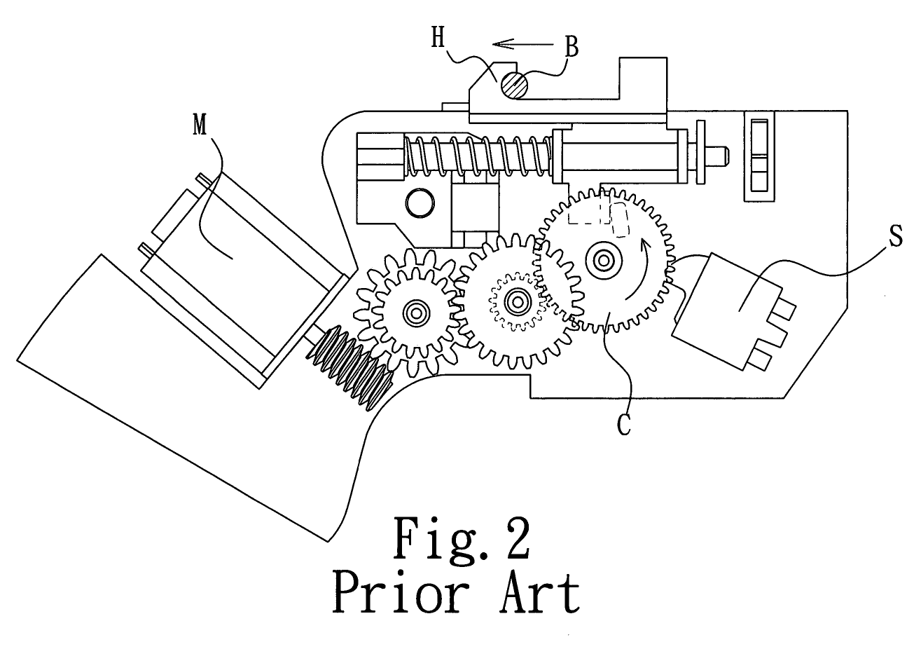

FIG. 3 is a schematic view, showing conventional locking device in FIG. 2 in which a cam of a locking device is stopped at an improper position;

FIG. 4 is a schematic view, showing the locking device according to a first preferred embodiment of the present invention in which the cam is not yet driven;

FIG. 5 is a schematic view, showing that the locking device in FIG. 4 in which the cam is driven to push the hook;

FIG. 6 is a schematic view, showing the locking device of a second preferred embodiment according to the present invention in which a control switch is constituted by a first electrode plate and a second electrode plate; and

FIG. 7 is a schematic view, showing the locking device of a third preferred embodiment according to the present invention in which a locking mechanism is acted by using a shaft pivoting manner.

### DETAILED DESCRIPTION OF THE PREFERRED EMBODIMENTS

According to the objects mentioned above, three preferred embodiments are presented to explain the technological means adopted in the present invention and the effects thereof by reference to the accompanying figures.

Only a locking device for locking a tray of an disc drive is used to illustrate the present invention in the embodiments, but the locking device is not limited to the application, it also can be applied on control of a cover opening or closing on the electronic device for allowing a user to place a disc directly into the electronic device.

Besides, the locking device is installed on the tray according to the embodiments, and a related component engaged with the locking device is a hooking portion, which is installed on a lower cover of the disc drive. This kind of disposition is used to explain the technological means used in the present invention and the effects thereof. But, the present invention is not limited to this disposition type. Moreover, the hook controlling device can be installed on a housing of the disc drive and the hooking portion is installed on the tray; as long as the locking mechanism and the hooking portion can be engaged with each other effectively to lock the tray in the disc drive.

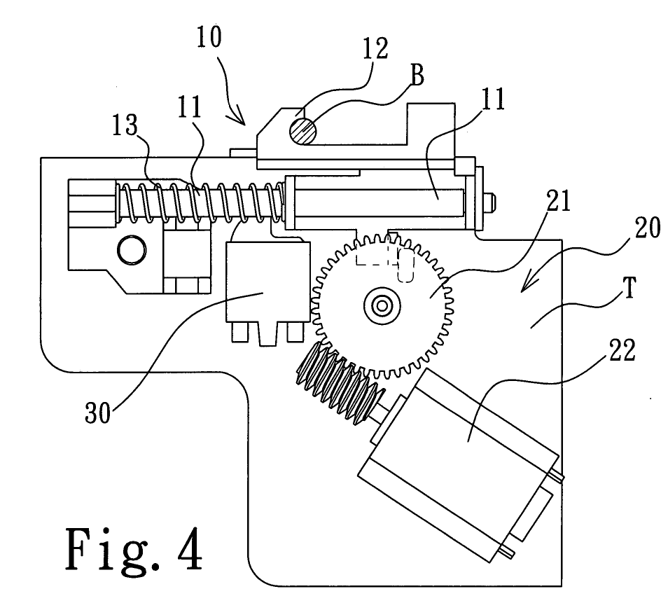

Please refer to FIG. 4. FIG. 4 is a schematic view showing a locking device of a first preferred embodiment according to the present invention in which the cam is not yet driven.

The locking device according to the present invention is used to engage or release the hooking portion B so as to control the tray T to be loaded in or ejected out of the disc drive. The locking device comprises a locking mechanism 10, a driver set 20, and a control switch 30.

The locking mechanism 10 comprises a shaft 11, a hook 12, and an elastic element 13, in which the shaft 11 is installed on the surface of the tray T and the hook 12 is installed on the tray T and connected with the shaft 11 to move on the tray T along the shaft 11. Besides, the elastic element 13 is covered around the shaft 11 between the tray T and the hook 12. Therefore, when the hook 12 is located at a first position (as FIG. 4 shows), it is engaged with the hooking portion B to allow the tray T to be fixed inside of the disc drive; and when the hook 12 is moved to a second position, the hooking portion B is released to allow the tray T to be ejected out of the disc drive. Furthermore, the elastic element 13 tends to push the hook 12 to the first position.

According to the first embodiment, the driver set 20 comprises a cam 21 and a motor set 22. The cam 21 is driven by the motor set 22 to push the hook 12 moving from the first position to the second position so as to release the hooking portion B to cause the tray T being ejected out of the disc drive.

Furthermore, the control switch 30 is installed on a moving route of the hook 12 between the first and the second positions. When the hook 12 is pushed by the cam 21 and out of the first position, the hook 12 triggers the control switch 30 immediately so that two electrodes of the control switch 30 connect with each other to form a equipotential state; and when the hook 12 is pushed back to the first position by the elastic element 13, the hook 12 then immediately releases the control switch 30 to disconnect two electrodes of the control switch 30 and form a potential difference. According to detection of the potential change, the motor set 22 is commended to stop immediately. Whereby, the motor set 22 obtain an enough braking distance for the cam 21 to further rotate due to the inertia of the motor set 22 or the signal delay to prevent the cam 21 to push the hook 12 again or stop at a position hindering the hook 12 backing to the first position.

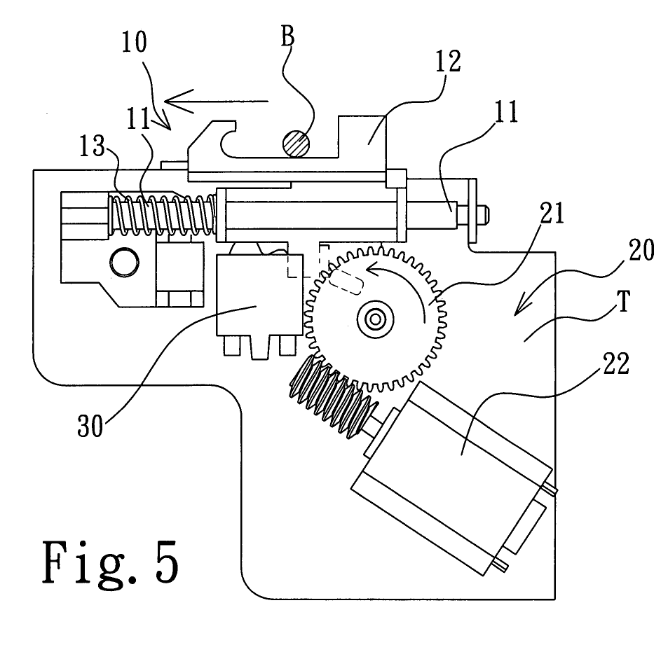

Please refer to FIG. 5. FIG. 5 is schematic view, showing that the locking device in FIG. 4 in which the cam is driven to push the hook.

When the disc tray T is intended to eject out of the disc drive, the motor set 22 is first driven which in turn drive the cam 21 to rotate and push the hook 12. When the hook 12 is pushed to leave the first position, it triggers the control switch 30 positioned on the moving route of the hook 12 to cause the switch 30 at an equipotential state, and when the hook 12 is located at the second position or moved between the first and the second positions, the control switch 30 is kept at the equipotential state. When the hook 12 is back to the first position, the control switch 30 is then returned to a state that a certain potential difference exists therein. At this time, it means that the hook 12 have been accurately back to the first position and thus the motor set 22 stop running so that the motor set 22 obtain an enough braking distance to respond the inertia generated after the motor set 22 stops.

According to the locking device of the present invention, the control switch 30 is a limit switch in this embodiment. When the hook 12 is pushed to leave the first position to trigger the control switch 30, the electrodes on the control switch 30 are connected with each other to form an equipotential state owing to the contact between them. When the hook 12 is back to the first position, the electrodes of the control switch 30 are separated from each other accordingly to generate a potential difference. Whereby, the system can determine whether the hook 12 is accurately returned to the first position based on the potential change of the control switch 30.

If the cam 21 is not stopped in time and pushes the hook 12 again, an equipotential state of the control switch 30 is formed again and the system will know that the hook 12 is not located at the first position correctly. Then, the motor set 22 is driven to rotate reversely immediately or continues driving the cam 21 to rotate until a potential difference is formed in the control switch 30, which means the hook 12 is returned to the first position correctly.

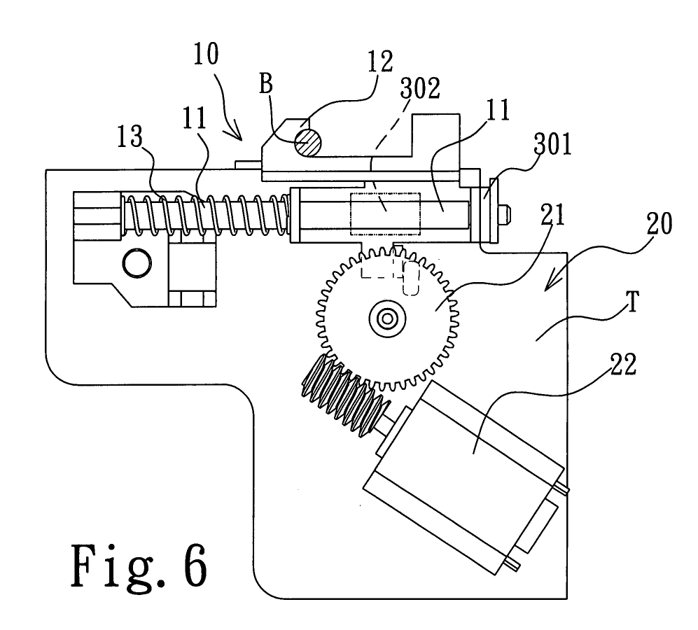

Furthermore, the control switch 30 of the present invention is not limited to a limit switch. Please refer to FIG. 6. FIG. 6 is a schematic view, showing the locking device of a second preferred embodiment according to the present invention. The structure of the control switch 30 of the second preferred embodiment is installed on the tray T and constituted by a first electrode plate 301 possessing positive electric charges and a second electrode plate 302 possessing negative electric charges, in which the first electrode plate 301 contacts with the hook 12 when the hook 12 is located at the first position, and the second electrode plate 302 is always kept contacting with the hook 12 whatever the position thereof is.

Therefore, when the hook 12 is located at the first position and contacts with the first electrode plate 301, the electrode plates mentioned above are communicated with each other by the hook 12 to generate an equipotential therein; and when the hook 12 is pushed to leave the first position and disconnects with the first electrode plate 301, the electrode plates are separated to generate a potential difference between the two electrode plates. Whereby, the system can determine whether the hook 12 is located at the first position correctly and control the motor set 22 to stop or rotate based on the change of the potential.

According to the present invention, when the hook 12 is located at the first position, the control switch 30 is at a first potential state, and when the hook 12 is pushed to leave the first position, the control switch 30 is at another potential state. Therefore, the position of the hook 12 changes the potential of the control switch 30 directly to allow the system to control the motor set 22 based on the detected potential and then accurately control the motor to either rotate or stop to cause the hook 12 stopping at the first position accurately.

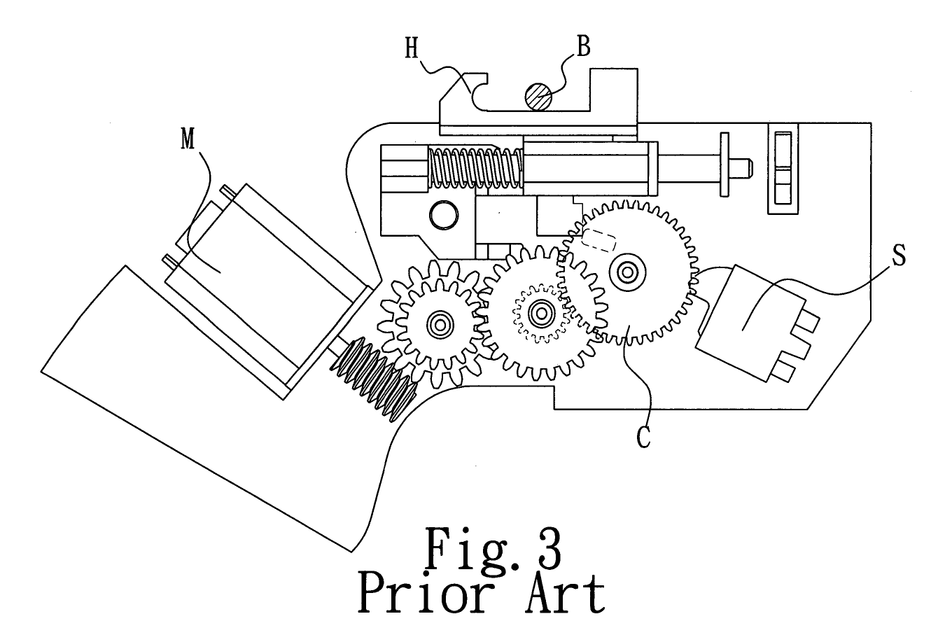

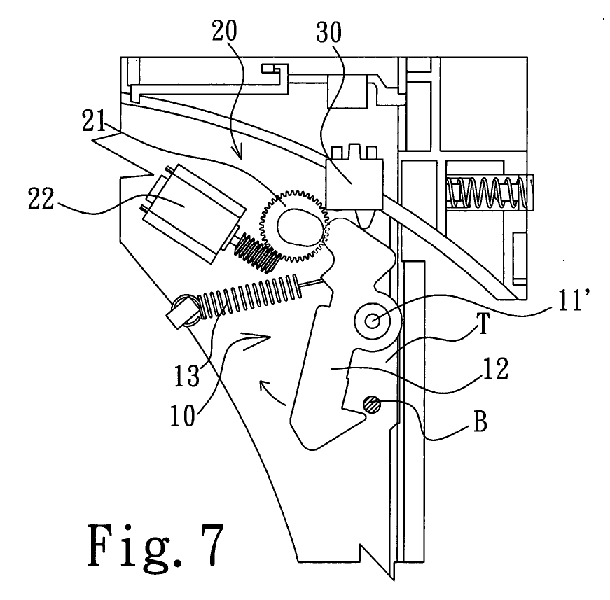

Please refer to FIG. 7. FIG. 7 is a schematic view showing a locking device of a third preferred embodiment according to the present invention. The figure shows that the locking mechanism is acted by means of a shaft pivoting manner. The components in FIG. 7 are the same as those in FIGS. 3 and 5, they are expressed as same component numbers. In the third embodiment, the shaft 11 in the locking mechanism 10 is equivalently replaced by an axial shaft 11′. The hook 12 is pivotally connected on the surface of the tray T through the axial shaft 11′ to allow the hook 12 rotating around the axial shaft 11′ to either the first or the second position. The locking mechanism 10 further comprises an elastic element 13; it preferable that the elastic element 13 is a tension spring or torsion spring and both ends thereof are respectively connected to the hook 12 and the surface of the tray T to allow the hook 12 to move toward the first position.

In the current embodiment, the disposition positions of the driver set 20 and the control switch 30 are the same as those disclosed in the first embodiment. And, the driver set 20 is also constituted by the cam 21 and the motor set 22 and the cam 21 is similarly used to push the rear end of the hook 12 to cause it leaving the first position and releasing the hooking portion B. Meanwhile, the rear end of the hook 12 triggers the control switch 30 to allow it being communicated and further to be in an equipotential state, as shown in FIG. 7. When the hook 12 is rotated from the second position to the first position by means of the elastic element 13, the rear end of the hook 12 releases the control switch 30 to generate a potential difference again and allow the motor set 22 to stop rotating immediately. Whereby, the motor set 22 can obtain a longer braking distance so that the problem that the inertia generated from the motor set 22 causes the cam 21 to push the hook 12 again or hinder the hook 12 from being recovered can be solved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A locking device, comprising:
a hooking portion;
a locking mechanism, comprising a shaft and a hook, said hook moving relative to said shaft between a first position and a second position, said hook being engaged with said hooking portion when said hook is located at said first position, and said hooking portion being released when said hook is located at said second position;
an elastic element for providing an elastic force to push said hook toward said first position;
a driver set for driving said hook to move from said first position to said second position; and
a control switch installed on the route said hook follows when moving between said first and second positions, whereby said control switch is used for detecting the position of said hook and, when said hook is moved from said first position, said hook triggers said control switch so as to change a potential state of said control switch.

2. (canceled)

3. The locking device according to claim 1, wherein said elastic element is a tension spring.

4. The locking device according to claim 1, wherein said driver set comprises:
a cam for driving said hook to move from said first position to said second position; and
a motor set for driving said cam to rotate.

5. The locking device according to claim 1, wherein said control switch is a limit switch.

6. (canceled)

7. (canceled)

8. The locking device according to claim 1, wherein said elastic element is a torsion spring.

9. (canceled)

10. A locking device comprising:
a hooking portion;
a hook moving between a first position and a second position, said hook being engaged with said hooking portion when said hook is located at said first position, and said hooking portion being released when said hook is located at said second position; and
a control switch installed on the route said hook follows when moving between said first and second positions,
wherein said hook is at said first position, said control switch has a first state, and, when said hook leaves said first position, said control switch is changed to a second state,
wherein said control switch is maintained at said second state until said hook is back to said first position.
